(19) United States
(12) Patent Application Publication
(10) Pub. No.: US 2012/0148443 A1
(43) Pub. Date: Jun. 14, 2012

(54) NANOWIRE PREPARATION METHODS, COMPOSITIONS, AND ARTICLES

(76) Inventor: David R. Whitcomb, Woodbury, MN (US)

(21) Appl. No.: 13/290,510

(22) Filed: Nov. 7, 2011

Related U.S. Application Data
(60) Provisional application No. 61/421,290, filed on Dec. 9, 2010.

(51) Int. Cl. C22C 5/06; D02G 3/00; C22B 11/00; B82Y 30/00

(52) U.S. Cl. 420/501; 75/392; 420/591; 428/401; 977/762

(57) ABSTRACT

Nanomaterial preparation methods, compositions, and articles are disclosed and claimed. Such methods can provide nanomaterials with improved morphologies relative to previous methods. Such materials are useful in electronic applications.

### CROSS REFERENCE TO RELATED APPLICATIONS

This application claims the benefit of U.S. Provisional Application No. 61/421,290, filed Dec. 9, 2010, entitled COORDINATION COMPOUND CATALYSIS OF METAL ION REDUCTION, METHODS, COMPOSITIONS, AND ARTICLES, which is hereby incorporated by reference in its entirety.

### BACKGROUND

The general preparation of silver nanowires (10-200 aspect ratio) is known. See, for example, Angew. Chem. Int. Ed. 2009, 48, 60, Y. Xia, Y. Xiong, B. Lim, S. E. Skrabalak, which is hereby incorporated by reference in its entirety. Such preparations typically employ Fe²⁺ or Cu²⁺ ions to “catalyze” the wire formation over other morphologies. The controlled preparation of silver nanowires having desired lengths and widths, however, is not known. For example, the Fe²⁺ produces a wide variety of lengths or thicknesses and the Cu²⁺ produces wires that are too thick for many applications.

The metal ions used to catalyze wire formation are generally primarily reported to be provided as a metal halide salt, usually as a metal chloride, for example, FeCl₂ or CuCl₂. See, for example, J. Jiu, K. Murai, D. Kim, K. Kim, K. Suganuma, Mat. Chem. & Phys., 2009, 114, 333, which refers to NaCl, CoCl₂, CuCl₂, NiCl₂ and ZnCl₂; Japanese patent application publication JP2009155674, which describes SnCl₄; S. Nandikonda, “Microwave Assisted Synthesis of Silver Nanorods,” M. S. Thesis, Auburn University, Aug. 9, 2010, which refers to NaCl, KCl, MgCl₂, CaCl₂, MnCl₂, CuCl₂, and FeCl₃; S. Nandikonda and E. W. Davis, “Effects of Salt Selection on the Rapid Synthesis of Silver Nanowires,” Abstract INOR-299, 240th ACS National Meeting, Boston, Mass., Aug. 22-27, 2010, which discloses NaCl, KCl, MgCl₂, CaCl₂, MnCl₂, CuCl₂, FeCl₃, Na₂S, and NaI; Chinese patent application publication CN101934377, which discloses Mn²⁺; Y. C. Lu, K. S. Chou, Nanotech., 2010, 21, 215707, which discloses Pd²⁺; and Chinese patent application publication CN102029400, which discloses NaCl, MnCl₂, and Na₂S.

### SUMMARY

At least some embodiments provide methods comprising providing a composition comprising at least one first reducible metal ion and at least one compound comprising: at least one second metal atom and at least one other atom attached to the at least one second metal atom by at least one coordinate covalent bond, where the at least one second metal atom differs in atomic number from the at least one first reducible metal ion; and reducing the at least one first reducible metal ion to at least one first metal.

In at least some embodiments, the at least one first reducible metal ion may, for example, comprise one or more of at least one coinage metal ion, at least one ion of an element from IUPAC Group 11, or at least one silver ion.

In at least some embodiments, the at least one other atom may, for example, comprise at least one oxygen atom, at least one nitrogen atom, at least one sulfur atom, at least one phosphorus atom, or at least one selenium atom.

In at least some embodiments, the at least one second metal atom comprises at least one element from IUPAC Groups 3, 4, 5, 6, 7, 8, 9, or 10, or the at least one second metal atom may, in some cases, comprise at least one element from IUPAC Group 10.

In some cases, the at least one second compound comprises at least one heterocyclic aromatic moiety, such as, for example, at least one benzonitrile moiety, or at least one bipyridine moiety, or at least one terpyridine moiety, or at least one methylbenzimidazole moiety.

Other embodiments provide the at least one first metal produced according to such methods.

Still other embodiments provide at least one metal nanowire comprising the at least one first metal produced according to such methods. Such metal nanowires may, in some cases, comprise an aspect ratio between about 50 and about 10,000. The average diameter of such metal nanowires may, for example, be between about 10 nm and about 300 nm, or from about 25 nm to about 260 nm. An exemplary metal nanowire is a silver nanowire.

Yet still other embodiments provide articles comprising the at least one first metal produced according to such methods. Such articles may, for example, comprise at least one of an electronic display, a touch screen, a portable telephone, a cellular telephone, a computer display, a laptop computer, a tablet computer, a point-of-purchase kiosk, a music player, a television, an electronic game, an electronic book reader, a transparent electrode, a solar cell, a light emitting diode, an electronic device, a medical imaging device, or a medical imaging medium.

These embodiments and other variations and modifications may be better understood from the brief description of figures, description, exemplary embodiments, examples, figures, and claims that follow. Any embodiments provided are given only by way of illustrative example. Other desirable objectives and advantages inherently achieved may occur or become apparent to those skilled in the art. The invention is defined by the appended claims.

### BRIEF DESCRIPTION OF FIGURES

FIG. 1 shows an optical microscope image of the unpurified silver nanowire product of Example 1.

FIG. 2 shows an optical microscope image of the unpurified silver nanowire product of Example 2.

FIG. 3 shows an optical microscope image of the unpurified silver nanowire product of Example 3.

FIG. 4 shows an optical microscope image of the unpurified silver nanowire product of Example 4.

FIG. 5 shows an optical microscope image of the unpurified silver nanowire product of Example 5.

FIG. 6 shows an optical micrograph of the reaction product of comparative Example 6.

FIG. 7 shows an optical micrograph of the reaction product of comparative Example 7.

FIG. 8 shows an optical micrograph of the reaction product of comparative Example 8.

### DESCRIPTION

All publications, patents, and patent documents referred to in this document are incorporated by reference herein in their entirety, as though individually incorporated by reference.

U.S. Provisional Application No. 61/421,290, filed Dec. 9, 2010, entitled COORDINATION COMPOUND CATALYSIS OF METAL ION REDUCTION, METHODS, COMPOSITIONS, AND ARTICLES, is hereby incorporated by reference in its entirety.

The Applicant has recognized that coordination compounds, such as, for example, (benzonitrile)₂PdCl₂ and (benzonitrile)₂PtCl₂, can be used to prepare silver nanowires. A range of coordination compounds, such as, for example, transition metal coordination compounds, may be employed and are useful in this application.

### Reducible Metal Ions and Metal Products

Some embodiments provide methods comprising reducing at least one reducible metal ion to at least one metal. A reducible metal ion is a cation that is capable of being reduced to a metal under some set of reaction conditions. In such methods, the at least one first reducible metal ion may, for example, comprise at least one coinage metal ion. A coinage metal ion is an ion of one of the coinage metals, which include copper, silver, and gold. Or such a reducible metal ion may, for example, comprise at least one ion of an IUPAC Group 11 element. An exemplary reducible metal ion is a silver cation. Such reducible metal ions may, in some cases, be provided as salts. For example, silver cations might, for example, be provided as silver nitrate.

In such embodiments, the at least one metal is that metal to which the at least one reducible metal ion is capable of being reduced. For example, silver would be the metal to which a silver cation would be capable of being reduced.

These methods are also believed to be applicable to reducible metal cations other than silver cations, including, for example reducible cations of other IUPAC Group 11 elements, reducible cations of other coinage metals, and the like. These methods may also be used to prepare products other than nanowires, such as, for example, nanocubes, nanorods, nanopyramids, nanotubes, and the like. Such products may be incorporated into articles, such as, for example, transparent electrodes, solar cells, light emitting diodes, other electronic devices, medical imaging devices, medical imaging media, and the like.

### Coordination Compounds

Some embodiments provide methods for metal ion reduction in the presence of at least a compound comprising at least one second metal atom and at least one other atom attached to the at least one second metal atom by a coordinate covalent bond. Such a compound may be a coordination compound, such as, for example, a transition metal coordination compound. Such a coordinate covalent bond may sometimes be referred to as a dipolar bond, a coordinate link, a dative bond, or a semi-polar bond. Such a bond may, for example, be formed from a neutral electron pair from the at least one other atom and an ionic form of the at least one second metal atom. Coordination compounds are described in, for example, “Coordination Chemistry” and “Coordination Complexes,” McGraw-Hill Encyclopedia of Chemistry, 2d ed., S. P. Parker, Jr., ed., 1993, 250-257, which are hereby incorporated by reference in their entirety. In some embodiments, the at least one second atom may also possess other bonds, such as, for example, ionic bonds, covalent bonds, coordinate covalent bonds, and the like, that are attached to yet other atoms, such as, for example, chlorine atoms. These and other embodiments may be understood from the examples and embodiments described hereafter.

Such coordination compounds may, in some cases, comprise at least one element from IUPAC Groups 3, 4, 5, 6, 7, 8, 9, or 10, such as, for example, palladium or platinum. In some cases, such coordination compounds may, for example, comprise at least one oxygen atom, at least one nitrogen atom, at least one sulfur atom, at least one phosphorus atom, or at least one selenium atom. Such coordination compounds may, in some cases, comprise at least one heterocyclic aromatic moiety, such as, for example, at least one benzonitrile moiety, or at least one bipyridine moiety, or at least one terpyridine moiety, or at least one methylbenzimidazole moiety. Exemplary coordination compounds are (benzonitrile)₂PdCl₂ and (benzonitrile)₂PtCl₂.

### Nanostructures, Nanostructures, Nanowires, and Articles

In some embodiments, the metal product formed by such methods is a nanostructure, such as, for example, a one-dimensional nanostructure. Nanostructures are structures having at least one “nanoscale” dimension less than 300 nm. Examples of such nanostructures are nanorods, nanowires, nanotubes, nanopyramids, nanoprisms, nanoplates, and the like. “One-dimensional” nanostructures have one dimension that is much larger than the other two nanoscale dimensions, such as, for example, at least about 10 or at least about 100 or at least about 200 or at least about 1000 times larger.

Such one-dimensional nanostructures may, in some cases, comprise nanowires. Nanowires are one-dimensional nanostructures in which the two short dimensions (the thickness dimensions) are less than 300 nm, preferably less than 100 nm, while the third dimension (the length dimension) is greater than 1 micron, preferably greater than 10 microns, and the aspect ratio (ratio of the length dimension to the larger of the two thickness dimensions) is greater than five. Nanowires are being employed as conductors in electronic devices or as elements in optical devices, among other possible uses. Silver nanowires are preferred in some such applications.

Such methods may be used to prepare nanostructures other than nanowires, such as, for example, nanocubes, nanorods, nanopyramids, nanotubes, and the like. Nanowires and other nanostructure products may be incorporated into articles, such as, for example, electronic displays, touch screens, portable telephones, cellular telephones, computer displays, laptop computers, tablet computers, point-of-purchase kiosks, music players, televisions, electronic games, electronic book readers, transparent electrodes, solar cells, light emitting diodes, other electronic devices, medical imaging devices, medical imaging media, and the like.

### Preparation Methods

A common method of preparing nanostructures, such as, for example, nanowires, is the “polyol” process. Such a process is described in, for example, Angew. Chem. Int. Ed. 2009, 48, 60, Y. Xia, Y. Xiong, B. Lim, S. E. Skrabalak, which is hereby incorporated by reference in its entirety. Such processes typically reduce a metal cation, such as, for example, a silver cation, to the desired metal nanostructure product, such as, for example, a silver nanowire. Such a reduction may be carried out in a reaction mixture that may, for example, comprise one or more polyols, such as, for example, ethylene glycol (EG), propylene glycol, butanediol, glycerol, sugars, carbohydrates, and the like; one or more protecting agents, such as, for example, polyvinylpyrrolidinone (also known as polyvinylpyrrolidone or PVP), other polar polymers or copolymers, surfactants, acids, and the like; and one or more metal ions. These and other components may be used in such reaction mixtures, as is known in the art. The reduction may, for example, be carried out at one or more temperatures from about 120° C. to about 190° C., or from about 80° C. to about 190° C.

### Exemplary Embodiments

U.S. Provisional Application No. 61/421,290, filed Dec. 9, 2010, entitled COORDINATION COMPOUND CATALYSIS OF METAL ION REDUCTION, METHODS, COMPOSITIONS, AND ARTICLES, which is hereby incorporated by reference in its entirety, disclosed the following 31 non-limiting exemplary embodiments:

A. A method comprising:

providing a composition comprising:
at least one first compound comprising at least one first reducible metal ion,
at least one second compound comprising at least one second metal atom and at least one other atom attached to the at least one second metal atom by at least one coordinate covalent bond, said at least one second metal atom differing in atomic number from said at least one first reducible metal ion, and
at least one solvent; and reducing the at least one first reducible metal ion to at least one first metal.
   B. The method of embodiment A, wherein the composition further comprises at least one protecting agent.
   C. The method of embodiment B, wherein the at least one protecting agent comprises at least one of: one or more surfactants, one or more acids, or one or more polar polymers.
   D. The method of embodiment B, wherein the at least one protecting agent comprises polyvinylpyrrolidinone.
   E. The method of embodiment B, further comprising inerting the at least one protecting agent.
   F. The method of embodiment A, wherein the at least one first reducible metal ion comprises at least one coinage metal ion.
   G. The method of embodiment A, wherein the at least one first reducible metal ion comprises at least one ion of an element from IUPAC Group 11.
   H. The method of embodiment A, wherein the at least one first reducible metal ion comprises at least one ion of silver.
   J. The method of embodiment A, wherein the at least one first compound comprises silver nitrate.
   K. The method of embodiment A, wherein the at least one other atom comprises at least one oxygen atom, at least one nitrogen atom, at least one sulfur atom, at least one phosphorus atom, or at least one selenium atom.
   L. The method of embodiment A, wherein the at least one second metal atom comprises at least one element in IUPAC Groups 3-10.
   M. The method of embodiment A, wherein the at least one second metal atom comprises at least one element in IUPAC Group 10.
   N. The method of embodiment A, wherein the at least one second metal atom comprises palladium or platinum.
   P. The method of embodiment A, wherein the at least one second compound comprises at least one aromatic moiety.
   Q. The method of embodiment A, wherein the at least one second compound comprises at least one benzonitrile moiety.
   R. The method of embodiment A, wherein the at least one second compound comprises at least one palladium or platinum atom and at least one benzonitrile moiety.
   S. The method of embodiment A, wherein the at least one solvent comprises at least one polyol.
   T. The method of embodiment A, wherein the at least one solvent comprises at least one of: ethylene glycol, propylene glycol, glycerol, one or more sugars, or one or more carbohydrates.
   U. The method of embodiment A, wherein the composition has a ratio of the total moles of the at least one second metal to the moles of the at least one first reducible metal ion from about 0.0001 to about 0.1.
   V. The method of embodiment A, wherein the reduction is carried out at one or more temperatures from about 120° C. to about 190° C.
   W. The method of embodiment A, further comprising inerting one or more of: the composition, the at least one first compound, the at least one second compound, or the at least one solvent.
   X. The at least one first metal produced according to the method of embodiment A.
   Y. At least one article comprising the at least one first metal produced according to the method of embodiment A.
   Z. The at least one article of embodiment Y, wherein the at least one first metal comprises one or more nanowires, nanocubes, nanorods, nanopyramids, or nanotubes.
   AA. The at least one article of embodiment Y, wherein the at least one first metal comprises at least one object having an average diameter of between about 10 nm and about 500 nm.
   AB. The at least one article of embodiment Y, wherein the at least one first metal comprises at least one object having an aspect ratio from about 50 to about 10,000.
   AC. At least one metal nanowire with an average diameter of between about 10 nm and about 150 nm, and with an aspect ratio from about 50 to about 10,000.
   AD. The nanowire of embodiment AC, wherein the at least one metal comprises at least one coinage metal.
   AE. The nanowire of embodiment AC, wherein the at least one metal comprises at least one element of IUPAC Group 11.
   AF. The nanowire of embodiment AC, wherein the at least one metal comprises silver.
   AG. At least one article comprising the at least one metal nanowire of embodiment AC.

### EXAMPLES

### Example 1

To a 500 mL reaction flask was added 280 mL ethylene glycol (EG) and 2.3 g of 3.3 mM (benzonitrile)₂PdCl₂ in EG. This solution was stripped of at least some dissolved gases by bubbling N₂ into the solution for at least 2 hrs using a glass pipette at room temperature with mechanical stirring while at 100 rpm. (This operation will be referred to as “degassing” the solution in the sequel.) Stock solutions of 0.25 M AgNO₃ in EG and 0.77 M (based on moles of repeat units) polyvinylpyrrolidinone (PVP, 55,000 molecular weight) in EG were also degassed by bubbling N₂ into the solutions for 60 minutes. Two syringes were loaded with 20 mL each of the AgNO₃ and PVP solutions. The reaction mixture was heated to 155° C. under N₂ and the AgNO₃ and PVP solutions were added at a constant rate over 25 minutes via 12 gauge Teflon syringe needles. The reaction mixture was held at 145° C. for 90 minutes then allowed to cool to room temperature. From the cooled mixture, the reaction mixture was diluted by an equal volume of acetone, and centrifuged at 500 G for 45 minutes. The solid remaining after decantation of the supernatant was re-dispersed in 200 mL isopropanol by shaking for 10 minutes and centrifuged again, decanted and diluted with 15 mL isopropanol.

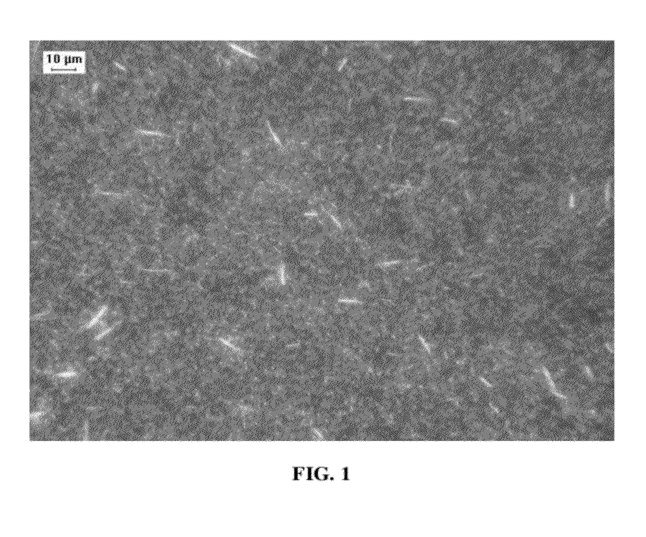

FIG. 1 shows an optical micrograph of the unpurified silver nanowires produced in the presence of this coordination compound. The average diameter of the silver nanowires was 61±11 nm, based on measurement of at least 100 wires.

### Example 2

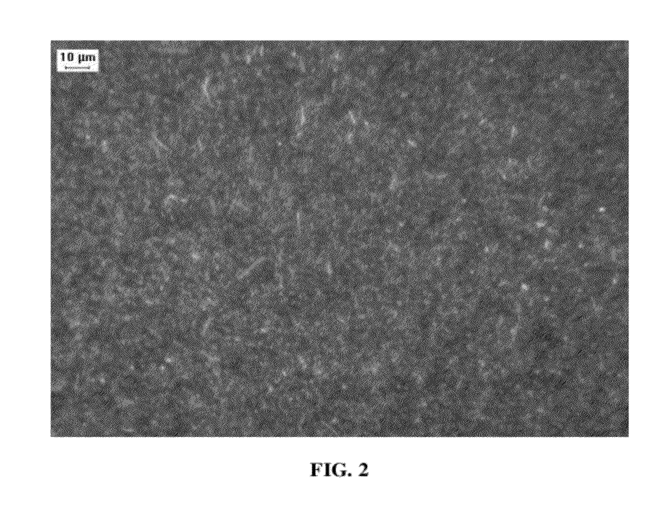

The procedure of Example 1 was repeated, using 3.4 g of 5.8 mM (benzonitrile)₂PtCl₂ in EG in place of the palladium solution. FIG. 2 shows an optical micrograph of the unpurified silver nanowires produced in the presence of this coordination compound.

### Example 3

The procedure of example 1 was repeated using 1.30 g of 7.0 mM FeCl₂ in EG and 30 mg of a solution having a concentration of 0.11 g of 2,2′:6′,2″-terpyridine:

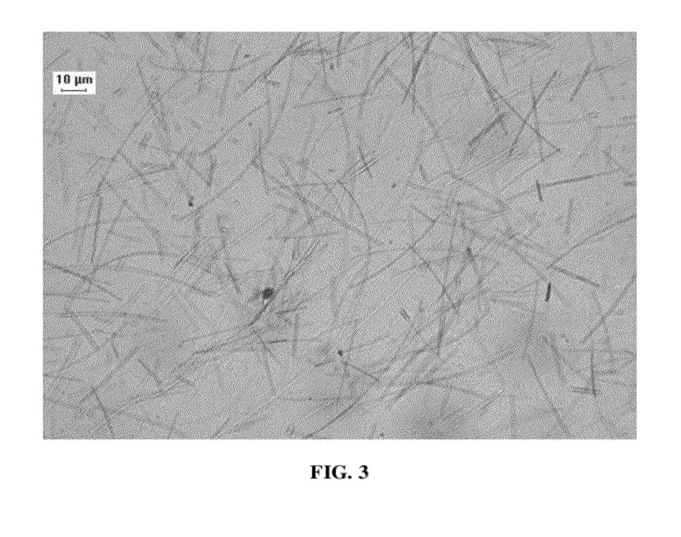

per gram of EG. FIG. 3 shows an optical micrograph of the silver nanowires produced, which had an average diameter of 126±33 nm and an average length of 27.1±18.3 μm, based on measurement of at least 100 wires.

### Example 4

The procedure of example 1 was repeated using 1.30 g of 7.7 mM FeCl2 in EG and 33 mg of bipyridine:

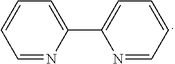

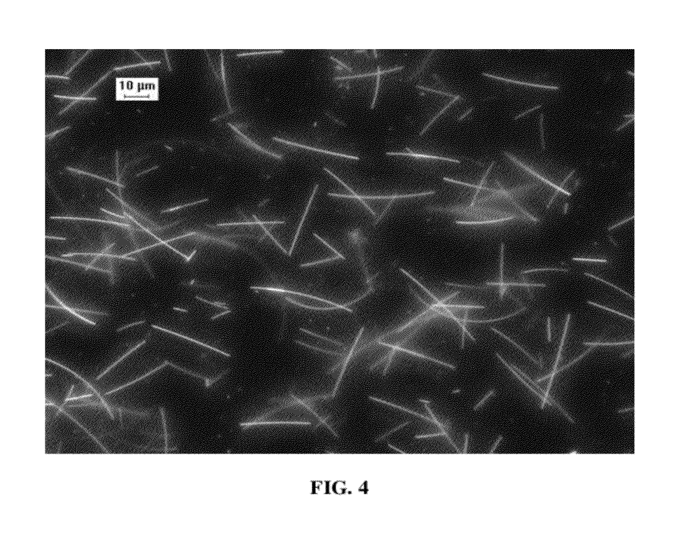

FIG. 4 shows an optical micrograph of the silver nanowires produced, which had an average diameter of 109±30 nm and an average length of 28±17 μm, based on measurement of at least 100 wires.

### Example 5

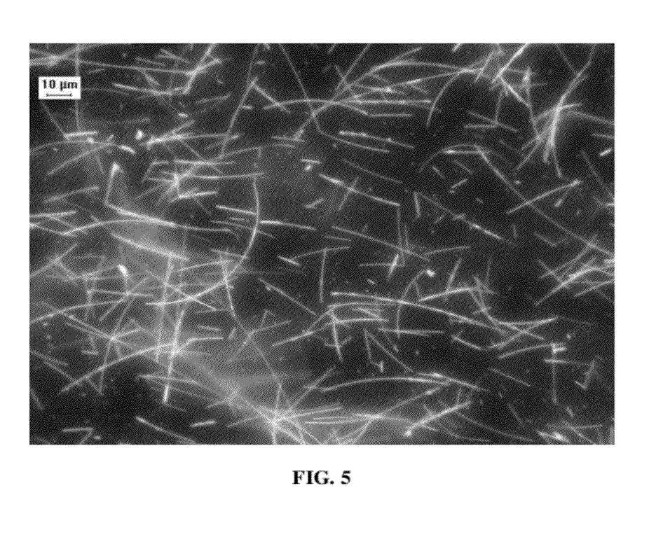

The procedure of example 1 was repeated using 1.3 g of 7.7 mM FeCl₂ in EG and 68 mg of 1-methylbenzimidazole. FIG. 5 shows an optical micrograph of the silver nanowires produced, which had an average diameter of 134±34 nm and an average length of 20±18 μm, based on measurement of at least 100 wires.

### Example 6

### Comparative

To a 500 mL reaction flask was added 280 mL ethylene glycol (EG) and 1.4 g of a freshly prepared 15 mM IrCl₃.3H₂O dispersion in EG. This solution was degassed for 2 hrs by bubbling N₂ into the solution using a glass pipette at room temperature with mechanical stirring while at 100 rpm. Stock solutions of 0.25 M AgNO₃ in EG and 0.84 M polyvinylpyrrolidinone (PVP) in EG were also degassed by bubbling N₂ into the solutions for at least 60 minutes. Two syringes were loaded with 20 mL each of the AgNO₃ and PVP solutions. The reaction mixture was heated to 155° C. under N₂ and the AgNO₃ and PVP solutions were added at a constant rate over 25 minutes via 12 gauge TEFLON® fluoropolymer syringe needles. The reaction was held at 155° C. for 90 minutes then allowed to cool to room temperature.

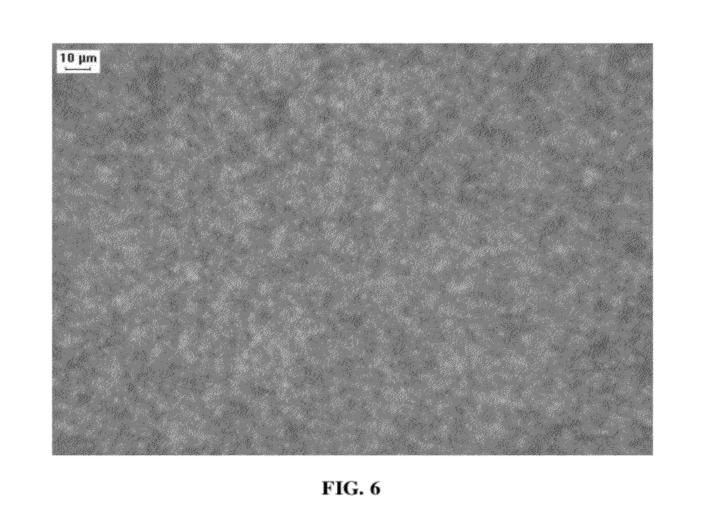

FIG. 6 shows the reaction mixture after 60 min of reaction. Visible are nanoparticles, microparticles, with only a few short nanowires.

### Example 7

### Comparative

The procedure of Example 3 was repeated, using 2.9 g of a freshly prepared 7.0 mM dispersion of K₂IrCl₆ in EG, instead of the IrCl₃.3H₂O dispersion. The reaction was carried out at 145° C., instead of 155° C.

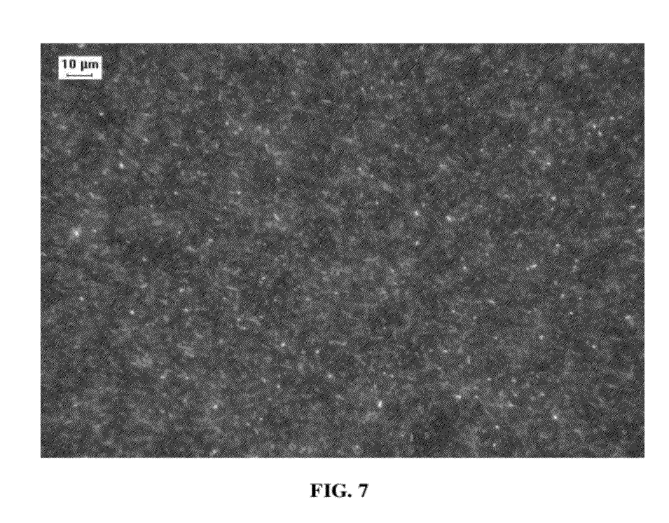

FIG. 7 shows the reaction mixture after 90 min of reaction. Only a few fine nanowires are visible.

### Example 8

### Comparative

The procedure of Example 3 was repeated, using 2.3 g of a freshly prepared 7.0 mM dispersion of 1 nCl₃.4H₂O in EG, instead of the IrCl₃.3H₂O dispersion.

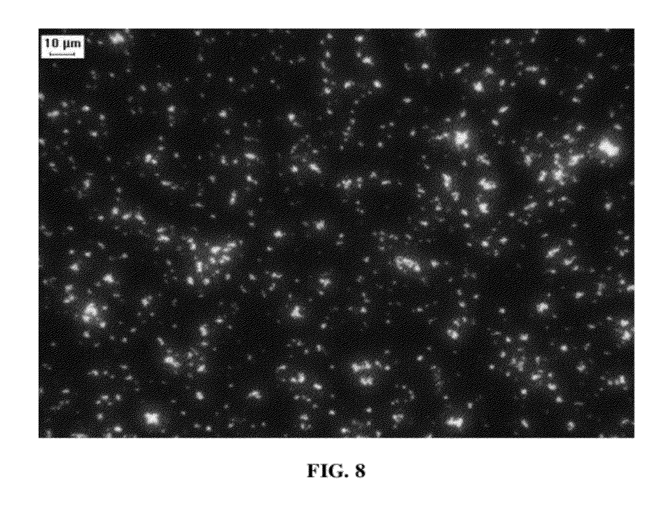

FIG. 8 shows the reaction mixture after 90 min of reaction. No nanowires are visible.

### Example 9

### Comparative

To a 100 mL reaction flask was added 50 mL ethylene glycol (EG) and 0.29 g of 7.0 mM AuCl₃ in EG. This solution was degassed for 2 hrs by bubbling N₂ into the solution using a glass pipette at room temperature with mechanical stirring while at 100 rpm. Stock solutions of 0.25 M AgNO₃ in EG and 0.84 M polyvinylpyrrolidinone (PVP) in EG were also degassed by bubbling N₂ into the solutions for at least 60 minutes. Two syringes were loaded with 3 mL each of the AgNO₃ and PVP solutions. The reaction mixture was heated to 145° C. under N₂ and the AgNO₃ and PVP solutions were added at a constant rate over 25 minutes via 20 gauge TEFLON® fluoropolymer syringe needles. The reaction was held at 145° C. for 150 minutes then allowed to cool to room temperature.

Samples taken after 15, 30, 60, 90, 120, and 150 min of reaction appeared to have only nanoparticles, but no nanowires.

The invention has been described in detail with reference to particular embodiments, but it will be understood that variations and modifications can be effected within the spirit and scope of the invention. The presently disclosed embodiments are therefore considered in all respects to be illustrative and not restrictive. The scope of the invention is indicated by the appended claims, and all changes that come within the meaning and range of equivalents thereof are intended to be embraced within.

What is claimed:

1. A method comprising:
providing a composition comprising:
at least one first reducible metal ion and
at least one compound comprising at least one second metal atom and at least one other atom attached to the at least one second metal atom by at least one coordinate covalent bond, the at least one second metal atom differing in atomic number from the at least one first reducible metal ion; and
reducing the at least one first reducible metal ion to at least one first metal.

2. The method according to claim 1, wherein the at least one first reducible metal ion comprises one or more of at least one coinage metal ion, at least one ion of an element from IUPAC Group 11, or at least one silver ion.

3. The method according to claim 1, wherein the at least one other atom comprises at least one oxygen atom, at least one nitrogen atom, at least one sulfur atom, at least one phosphorus atom, or at least one selenium atom.

4. The method according to claim 1, wherein the at least one second metal atom comprises at least one element from IUPAC Groups 3, 4, 5, 6, 7, 8, 9, or 10.

5. The method according to claim 1, wherein the at least one second metal atom comprises at least one element from IUPAC Group 10.

6. The method according to claim 1, wherein the at least one second compound comprises at least one heterocyclic aromatic moiety.

7. The method according to claim 1, wherein the at least one second compound comprises at least one of a benzonitrile moiety, a bipyridine moiety, a terpyridine moiety, or a methylbenzimidazole moiety.

8. The at least one first metal produced according to the method of claim 1.

9. At least one metal nanowire comprising the at least one first metal produced according to the method of claim 8.

10. The at least one metal nanowire according to claim 9, comprising an aspect ratio between about 50 and about 10,000.

11. The at least one metal nanowire according to claim 9, comprising an average diameter of between about 10 nm and about 300 nm.

12. The at least one metal nanowire according to claim 9, comprising an average diameter of between about 25 nm and about 260 nm.

13. The at least one metal nanowire according to claim 9, comprising at least one silver nanowire.

14. An article comprising the at least one first metal produced according to the method of claim 1.

15. The article according to claim 14, comprising at least one of an electronic display, a touch screen, a portable telephone, a cellular telephone, a computer display, a laptop computer, a tablet computer, a point-of-purchase kiosk, a music player, a television, an electronic game, an electronic book reader, a transparent electrode, a solar cell, a light emitting diode, an electronic device, a medical imaging device, or a medical imaging medium.
